(19) United States
(12) Patent Application Publication
(10) Pub. No.: US 2009/0197648 A1
(43) Pub. Date: Aug. 6, 2009

(54) TOUCH SCREEN ASSEMBLY, MOBILE TERMINAL HAVING THE TOUCH SCREEN ASSEMBLY, AND KEY INPUT METHOD ON THE MOBILE TERMINAL

(76) Inventors: Jee-Young Cheon, Daegu-si (KR); Yeon Woo Park, Seoul (KR); Sang Hyuck Lee, Seoul (KR)

Correspondence Address: BIRCH STEWART KOLASCH & BIRCH, PO BOX 747, FALLS CHURCH, VA, 22040-0747, US

(21) Appl. No.: 12/419,175

(22) Filed: Apr. 6, 2009

Related U.S. Application Data
(63) Continuation of application No. 11/502,482, filed on Aug. 11, 2006.

(30) Foreign Application Priority Data
Aug. 12, 2005 (KR) 10-2005-0074193
Sep. 13, 2005 (KR) 10-2005-0085259

(51) Int. Cl. H04M 1/00; G06F 3/041

(52) U.S. Cl. 455/566; 345/173

(57) ABSTRACT

A terminal is disclosed. The terminal includes a touch screen type display part for displaying key buttons used for a user to input information to the terminal, a speaker part for outputting an audio signal, when the user has correctly touched the key buttons, to inform the user that the key buttons have been correctly touched and inputted, and a control part for controlling the display part and the speaker part. According to the present invention, when a user of the terminal correctly touches the key buttons on the touch screen of the terminal, the user of the terminal can perceive, in the form of visual sensation, hearing sensation, and/or vibration sensation, that the key buttons have been correctly touched, and therefore, it is possible to more easily and conveniently manipulate the key buttons on the terminal having the touch screen.

This application is a Continuation of co-pending application Ser. No. 11/502,482 filed on Aug. 11, 2006; and this application claims the benefit of Korean Patent Application Nos. 10-2005-0074193, filed on Aug. 12, 2005 and 10-2005-0085259 filed on Sep. 13, 2005, which are hereby incorporated by reference as if fully set forth herein.

### BACKGROUND OF THE INVENTION

1. Field of the Invention

The present invention relates to a terminal, and more particularly, to a mobile terminal having a touch screen.

2. Discussion of the Related Art

With increasing development of information communication technologies, information and communication environments has been changing rapidly in recent times. Particularly, mobile communication terminals have been considered to be requisites for modern society, and have been widely used throughout the world. With the increasing demands of users due to the widespread use of the above-mentioned mobile communication terminals, not only a general voice call function, but also a variety of additional functions such as MP3 file player function and camera function have been added to the mobile communication terminals.

In recent years, there has been introduced a mobile communication terminal having a touch screen type display. When a user pushes push-button type mechanical key buttons of a conventional non-touch-screen type mobile communication terminal, the user can feel tactile sensation in which the key buttons have been slightly pushed inward, and therefore, the user of the terminal can easily recognize that the key buttons have been correctly pushed. However, the conventional touch screen type mobile communication terminal has problems in that, when the user of the terminal pushes the key buttons on the touch screen of the terminal, the user cannot feel tactile sensation in which the key buttons have been pushed, and therefore, the user of the terminal cannot easily recognize that the key buttons have been correctly pushed.

### SUMMARY OF THE INVENTION

Accordingly, the present invention is directed to a touch screen assembly, a mobile terminal having the touch screen assembly, and a key input method on the mobile terminal that substantially obviate one or more problems due to limitations and disadvantages of the related art.

An object of the present invention is to provide a mobile terminal constructed such that a user of the terminal can easily confirm, in the form of touch sensation, whether key buttons on a touch screen have been correctly pushed or not.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a terminal includes a touch screen type display part for displaying key buttons used for a user to input information to the terminal, and a touch screen protection film part formed on the display part, wherein the touch screen protection film part is formed into a shape corresponding to the key buttons such that, when the user of the terminal touches the key buttons, the user can feel touch sensation.

In another aspect of the present invention, a touch screen assembly includes a touch screen type display part for displaying input parts used for a user to input information, a vibrator for providing vibration to the display part when an input operation is carried out through the input parts, and a vibrator driving part for driving the vibrator, wherein the vibrator driving part provides a voltage square wave to the vibrator so as to instantaneously vibrate the display part.

In another aspect of the present invention, a terminal includes the above-described touch screen assembly according to the present invention.

In yet another aspect of the present invention, a key input method on a terminal having a touch screen, includes displaying input parts on a touch screen, sensing that a user has performed an input operation through the input parts, and, when the input operation is sensed, providing instantaneous vibration to the touch screen.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a mobile terminal according to a first embodiment of the present invention;

FIG. 2 is a sectional view taken along line I-I′ of FIG. 1;

FIG. 3 is a perspective view illustrating a mobile terminal according to a second embodiment of the present invention;

FIG. 4 is a schematic block diagram of the mobile terminal according to the second embodiment of the present invention;

FIG. 5 is a schematic block diagram illustrating a mobile terminal having a touch screen according to a third embodiment of the present invention;

FIG. 6 is a front view of the mobile terminal having the touch screen according to the third embodiment of the present invention;

FIGS. 7A and 7B are circuit diagrams schematically illustrating the construction of a vibrator of the mobile terminal according to the third embodiment of the present invention;

FIG. 8 is a front view illustrating a preferred position of a vibrator in a mobile terminal according to Embodiment 3-1 of the present invention;

FIGS. 9A and 9B are sectional views taken along line II-II′ of FIG. 8;

FIG. 10 is a front view illustrating a preferred position of a vibrator in a mobile terminal according to Embodiment 3-2 of the present invention; and

FIGS. 11A and 11B are sectional views taken along line III-III′ of FIG. 10.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention may be applied to various kinds of terminals, such as a game device, as well as mobile communication terminals, such as a personal digital assistant (PDA), a portable phone, and a smart phone. The following description of the present invention will be given on the assumption that the present invention is applied to the mobile terminal, specifically, the portable phone, for convenience of easy description.

Furthermore, the present invention may be applied to all kinds of mobile terminals having at least one touch screen type display part. For convenience of easy description, however, the following embodiments of the present invention will be described on the assumption that the mobile terminal according to the present invention includes two display parts, and at least one of the two display parts is a touch screen type display part.

Consequently, it should be noted that the scope of the present invention is not limited by the following embodiments.

### FIRST EMBODIMENT

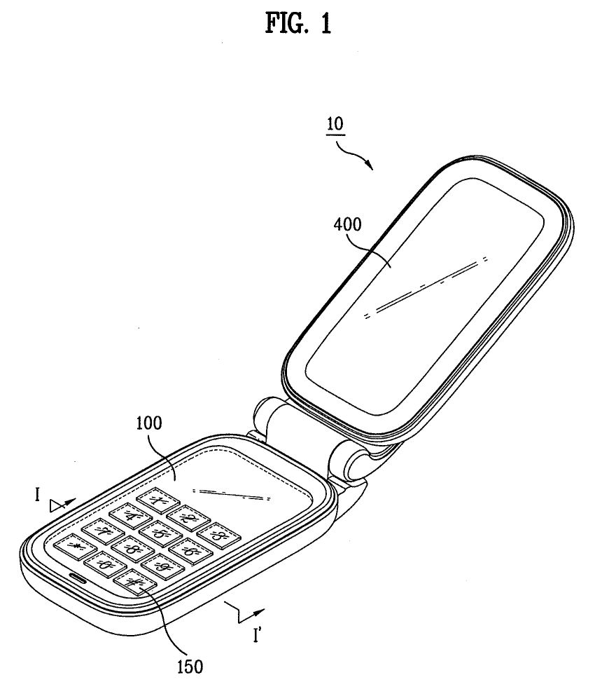

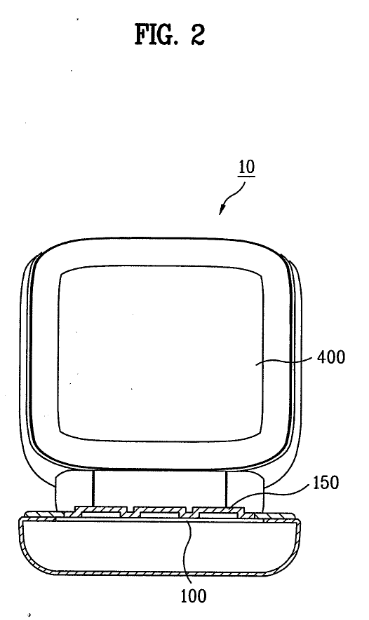

Hereinafter, a first embodiment of the present invention will be described in detail with reference to FIGS. 1 and 2. FIG. 1 is a perspective view illustrating a mobile terminal according to a first embodiment of the present invention, and FIG. 2 is a sectional view taken along line I-I′ of FIG. 1.

As shown in FIG. 1, the mobile terminal according to the first embodiment of the present invention preferably includes a first touch screen type display unit 100, a touch screen protection film part 150 formed at the front of the first display part 100, and a second display part 400, which is exclusively used as a display. The mobile terminal according to the present invention includes other components, such as a control part and a memory part, in addition to the above-mentioned components. However, the other components of the mobile terminal are not directly related to the present invention, and therefore, a description of the other components of the mobile terminal will not be given below for simplicity and clarity of description.

The first display part 100 is a touch screen that displays key buttons used to manipulate the mobile terminal. The second display part 400 displays information of the mobile terminal or motion pictures. The second display part 400 may be constructed with a touch screen like the touch screen of the first display part 100. The protection film part 150 is formed on the first display part 100. Preferably, the protection film part 150 is made of, but not limited to, a transparent material, such as transparent rubber, transparent silicon, or transparent plastic.

The formation of the protection film part 150 on the first display part 100 will be further described below with reference to FIG. 2.

FIG. 2 is a sectional view of a key button display section on the first display part 100 of the mobile terminal (taken along line I-I′ of FIG. 1). As shown in FIG. 2, the protection film part 150 is formed into a shape corresponding to the key buttons on the first display part 100 such that, when a user of the terminal touches the key buttons, the user can feel specific tactile sensation. FIG. 2 illustrates the protection film part 150 having rectangular convex parts corresponding to the key buttons on the first display part 100. However, the shape or the construction of the protection film part is not limited to the shape or construction of the protection film part 150 of FIG. 2. Further the shape and construction can be any shape or construction provided that the user can feel specific tactile sensation when the user of the terminal touches the key buttons.

With the above-described structure, the protection film part 150 can protect the surface of the touch screen and allow the user of the terminal to feel tactile sensation when the user presses the key buttons, and thus, to allow confirmation of the key buttons.

### SECOND EMBODIMENT

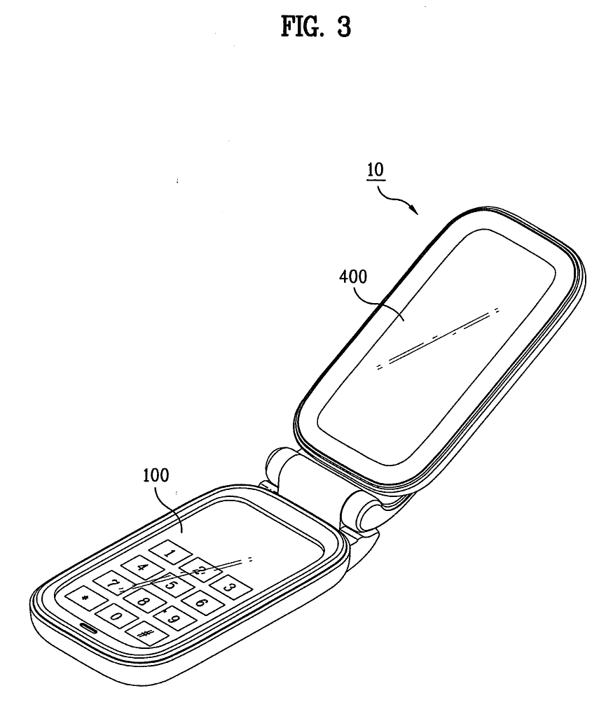

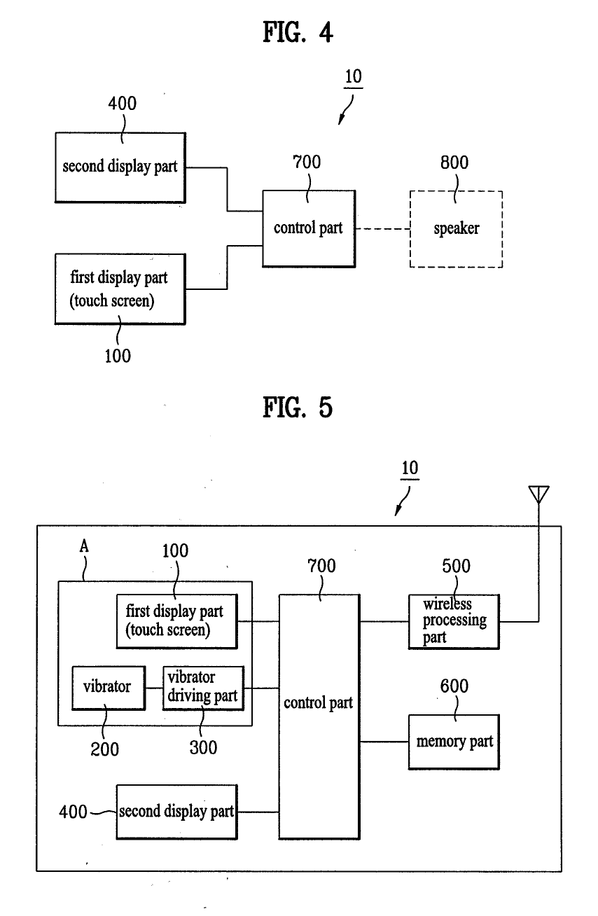

Hereinafter, a second embodiment of the present invention will be described in detail with reference to FIGS. 3 and 4. FIG. 3 is a perspective view illustrating a mobile terminal 10 according to a second embodiment of the present invention, and FIG. 4 is a schematic block diagram of the mobile terminal 10 according to the second embodiment of the present invention.

As shown in FIGS. 3 and 4, the mobile terminal 10 according to the second embodiment of the present invention preferably includes a first touch screen type display part 100, a second display part 400, and a control part 700. The mobile terminal 10 includes other components, such as a wireless transmitting and receiving part and a memory part, in addition to the above-mentioned components. However, the other components of the mobile terminal are not directly related to the present invention, and therefore, a description of the other components of the mobile terminal will not be given below for simplicity and clarity of description.

The first display part 100 is a touch screen that displays key buttons used to manipulate the mobile terminal. The second display part 400 displays information of the mobile terminal or motion pictures. The second display part 400 may be constructed with a touch screen like the touch screen of the first display part 100. The control part 700 controls the entire terminal.

When a user of the terminal touches one of the key buttons on the first display part 100, the control part 700 recognizes that one of the key buttons has been touched, and controls the first display unit 100 to temporarily change the shape of the touched key button for a predetermined period of time (e.g., 1 second) such that the user of the terminal can visually recognize that one of the key buttons has been correctly touched. For example, when the user of the terminal pushes one of the key buttons, for example, “1” key button, on the first display part 100, the control part 700 senses that the user of the terminal has touched the “1” key button, and controls the “1” key button such that the color of the “1” key button is changed or the shape of the “1” key button is enlarged or reversed. As a result, the user of the terminal can visually recognize that the “1” key button has been correctly touched.

In addition, the mobile terminal 10 may further include a speaker 800 as an option. In this case, the speaker 800 is constructed in a manner that when the user has correctly touched one of the key buttons on the touch screen, a predetermined sound can be outputted from the speaker 800 under the control of the control part 700. The predetermined sound may be a manufactured sound or a human voice. It is preferable that the sound outputted from the speaker is changed based on which key button is touched. Especially, in the case that the sound is a voice, it is preferable that, when the user of the terminal presses “1” key button or “2” key button, a voice corresponding to the “1” key button or the “2” key button (e.g., “one” or “two”), respectively, is outputted from the speaker. Further, it is possible that the control part 700 cannot determine which key button the user of the terminal has intended to touch because the user of the terminal simultaneously touches two or more buttons or touches the remaining area of the first display part 100 excluding the key button display section. In such a situation, it is preferable that an additional warning sound indicating input error is outputted from the speaker 800.

### THIRD EMBODIMENT

Hereinafter, the construction of a mobile terminal according to a third embodiment of the present invention will be described in detail with reference to FIG. 5. FIG. 5 is a schematic block diagram illustrating a mobile terminal 10 having a touch screen according to a third embodiment of the present invention.

As shown in FIG. 5, the mobile terminal 10 according to the third embodiment of the present invention includes a first display part 100, a vibrator 200, a vibrator driving part 300, a second display part 400, a wireless processing part 500, a memory part 600, and a control part 700. The mobile terminal 10 according to the present invention includes other components, such as a mobile broadcast receiving part, in addition to the above-mentioned components. However, the other components of the mobile terminal are not directly related to the present invention, and therefore, a description of the other components of the mobile terminal will not be given below for simplicity and clarity of description.

The first display part 100 is constructed in the form of a touch screen. The first display part 100 principally displays input parts used to manipulate the terminal, (e.g., key buttons) and allows a user of the terminal to press the key buttons through the touch screen in order to input information necessary to manipulate the terminal.

The vibrator 200 serves to provide vibration to the first display part 100. More specifically, when the user of the terminal has pressed the key buttons on the touch screen, the user can recognize that the key buttons have been touched and inputted. The vibrator driving part 300 serves to drive the vibrator 200. The vibration is transmitted to a finger of the user or a stylus pen through the first display part 100 such that the user can feel tactile sensation as if mechanical push buttons were slightly elastically pushed inward when the user of the terminal pushes the mechanical push buttons. Hereinafter, such tactile sensation will be referred to as “instantaneous vibration sensation,” and vibration which the vibrator 200 generates for the user of the terminal to feel the instantaneous vibration sensation will be referred to as “instantaneous vibration.” The instantaneous vibration sensation is most ideally realized when the vibrator 200 vibrates at a specific vibration frequency and/or a specific vibration magnitude, which will be described below in detail.

The first display part 100, the vibrator 200, and the vibrator driving part 300 may be mounted in the mobile communication terminal 10 in the form of a single touch screen assembly module.

The second display part 400 is an exclusive display part of the mobile communication terminal 10, which displays image and information necessary to use the terminal. The second display part 400 may be constructed with a touch screen like the touch screen of the first display part 100 to provide greater convenience in manipulation of the user of the terminal.

The memory part 600 serves to store various kinds of data necessary to operate the mobile terminal and data which the user of the terminal arbitrarily stores. The wireless processing part 500 serves to transmit and receive data in a wireless fashion such that the user of the terminal can perform mobile communication through a mobile communication network.

The control part 700 serves to control the entire terminal, including the first display part 100, the vibrator driving part 300, the second display part 400, the wireless processing part 500, and the memory part 600.

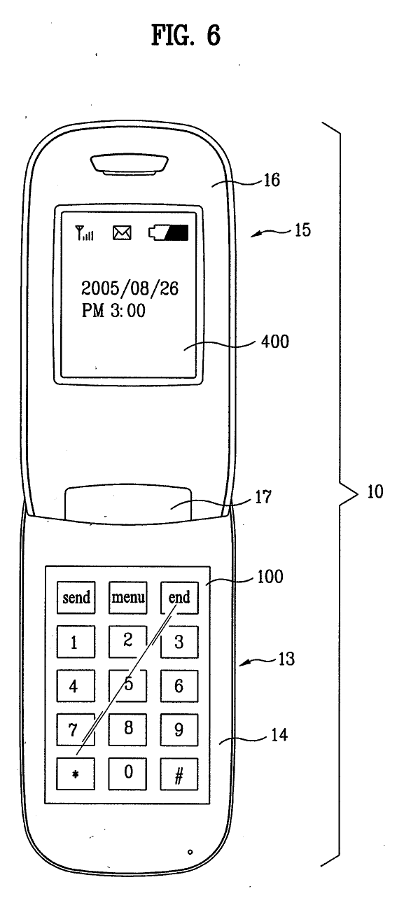

Hereinafter, the external structure of the mobile terminal 10 according to the third embodiment of the present invention will be described. FIG. 6 is a front view of the mobile terminal having the touch screen according to the third embodiment of the present invention.

As shown in FIG. 6, the mobile terminal 10 according to the present invention includes a first terminal body 13, which includes the first display part 100, a second terminal body 15, which includes the second display part 400, and a hinge part 17 for connecting the first terminal body 13 and the second terminal body 15 in a folder fashion. The first terminal body 13 and the second terminal body 15 includes a first housing 14 and a second housing 16, which define the external appearances of the first terminal body 13 and the second terminal body 15, respectively. The vibrator driving part 300, the wireless processing part 500, and the memory part 600 may be included in either the first terminal body 13 or the second terminal body 15. It is preferable, however, that the vibrator 200 is included in the first terminal body 13 including the first display part 100, which is a touch screen, which will be described below in detail.

With the above-stated construction of the mobile terminal according to the present invention, the vibrator 200 provides vibration in the terminal when the user of the terminal presses one of the key buttons on the touch screen. With the vibration, the user can recognize that the key button has been touched and the desired command has been inputted. A more detailed description is provided below.

It is possible for a user to inadvertently press or touch more than one key button at the same time. For example, the user may intend to press “5” key button but inadvertently presses “5” and “6” key buttons at the same time. In such a case, a feedback may be provided to notify that the user has incorrectly pressed or touched the key(s). Here, the feedback notification to the user can be in various forms, including no response (e.g., no vibration) or a warning sound.

1. Construction of Vibrator

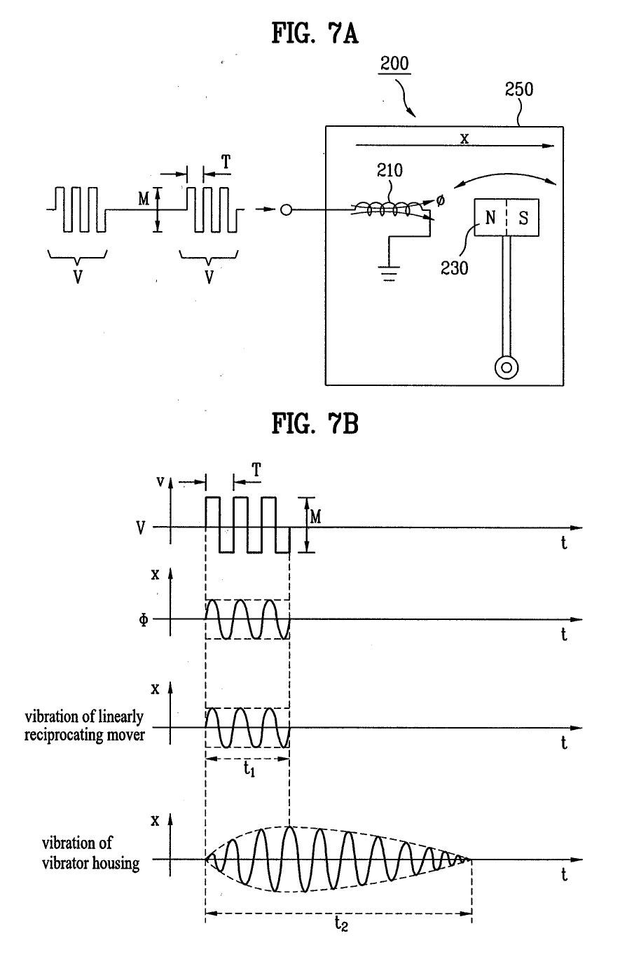

FIGS. 7A and 7B are circuit diagrams schematically illustrating the construction of the vibrator. As shown in FIG. 7A, the vibrator 200 includes a coil 210, a linearly reciprocating mover 230 having a permanent magnet disposed at a predetermined position thereof, and a vibrator housing 250.

When a user of the terminal touches one of the key buttons on the touch screen, the control part 700 recognizes that one of the key buttons has been touched, and transmits to the vibrator driving part 300 a specific signal indicating that one of the key buttons has been touched. Upon receipt, the vibrator driving part 300 generates a voltage square wave V corresponding to the specific signal.

When the voltage square wave V is inputted to the coil 210, a magnetic field of the coil 210 is changed based on the voltage square wave V. The change of the magnetic field of the coil 210 affects the permanent magnet of the linearly reciprocating mover 230. As a result, the linearly reciprocating mover 230 is linearly reciprocated in a direction indicated by x depending upon the change of the magnetic field of the coil 210, and therefore, the linearly reciprocating mover 230 impacts against the vibrator housing 250. Consequently, the vibrator 200 generates vibration corresponding to the inputted voltage square wave, i.e., vibration pulse in the direction of x.

This will be described in more detail with reference to FIG. 7B. The generation time of the magnetic field Φ of the coil 210 is equal to the application time of the voltage square wave V. Further, the moving time of the linearly reciprocating mover 230 is equal to the generation time of the magnetic field Φ of the coil 210. Consequently, the application time of the voltage square wave V, the generation time of the magnetic field Φ of the coil 210, and the moving time of the linearly reciprocating mover 230 are the same as indicated by t1 in FIG. 7B. Furthermore, the magnitude M of the voltage square wave V is constant. Therefore, the magnitude of the magnetic field of the coil 210 and the magnitude of the vibration of the linearly reciprocating mover 230 are constant during t1.

However, the vibration time t₂ of the vibrator housing 250 (see FIG. 7A) generated by the impact of the linearly reciprocating mover 230 against the vibrator housing 250 is approximately 10 times compared to the application time of the voltage square wave V due to the resonance of the vibrator housing 250. An experiment according to the present invention revealed that, when a voltage square wave having t₁=3 ms is inputted, the vibration time t₂ of the vibrator housing 250 is 30 ms. Moreover, the magnitude of the vibration of the vibrator housing 250 is gradually increased during t₁, and, after expiration of which gradually decreases. This means that the magnitude of the vibration pulse generated by the vibrator can be controlled by the number of cycle repetitions of the voltage square wave.

The vibration pulse of the vibrator housing allows for the user of the terminal to feel instantaneous vibration sensation when the user of the terminal pushes one of the key buttons on the touch screen.

2. Position of Vibrator

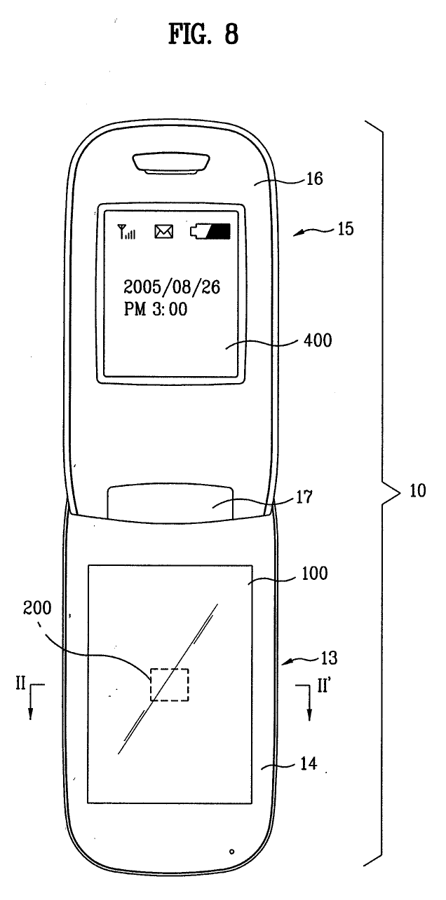

Hereinafter, preferable positions of a vibrator in a mobile terminal according to Embodiment 3-1 and Embodiment 3-2 of the present invention will be described with reference to FIGS. 8 to 11.

### EMBODIMENT 3-1

### Vibrator Positioned at the Center of the First Display Part

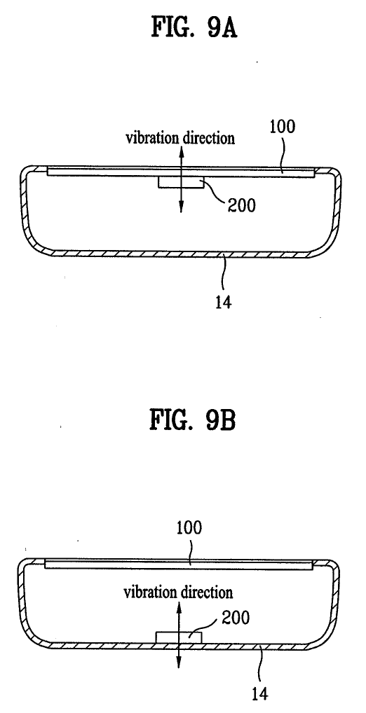

FIG. 8 is a front view illustrating a preferred position of a vibrator 200 in a mobile terminal according to Embodiment 3-1 of the present invention, and FIGS. 9A and 9B are sectional views taken along line II-II′ of FIG. 8.

As shown in FIGS. 8 and 9A, the vibrator 200 may be positioned at the center of the lower surface of the first display part. (Hereinafter, the surface of the first display part facing the interior of the housing, is referred to as a “lower surface” of the first display part). Preferably, the vibrator 200 is constructed such that the vibration direction of the vibrator 200 is perpendicular to the lower surface of the first display part.

When the vibrator 200 is positioned at the center of the first display part 100 as shown in FIG. 8, vibration is applied to the center of the first display part. With this, the vibration can be uniformly distributed on the first display part to provide the user of the terminal with more accurate feedback with respect to user input.

Further, when the vibrator is directly attached to the lower surface of the first display part 100 as shown in FIG. 9A, vibration can be directly transmitted to a stylus pen or a finger of the user of the terminal through the first display part. With this, the vibration can be transmitted more accurately to the user of the terminal.

Although the vibrator 200 is directly attached to the lower surface of the first display part 100 as described above, the vibrator may be constructed such that the vibrator is attached to the inside of the first housing of the first terminal body while being spaced apart from the first display part 100, as shown in FIG. 9B. In this case, the vibrator 200 does not directly apply vibration to the first display part 100, but applies vibration to the stylus pen or the finger of the user of the terminal through the first housing 14. Consequently, a possibility of the first display part 100 being damaged due-to the vibration is reduced.

### EMBODIMENT 3-2

### Vibrator Positioned at the Edge of the First Display Part

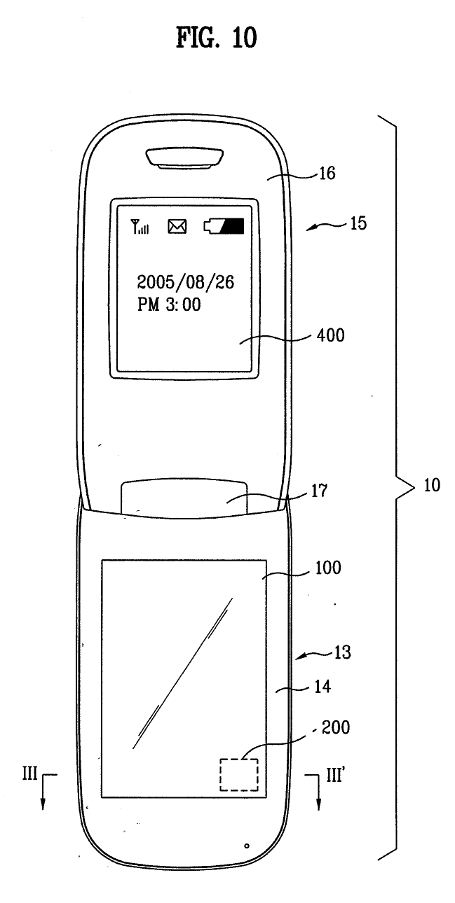

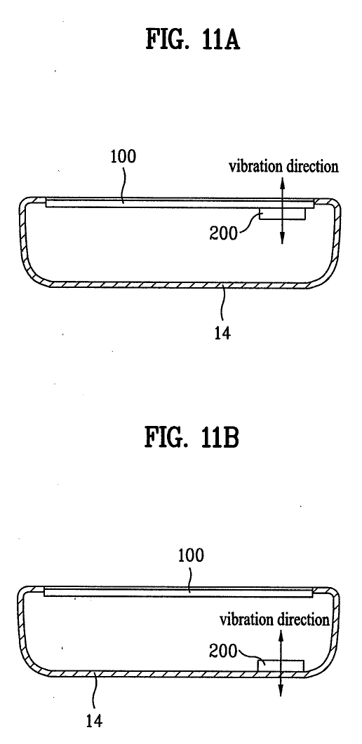

FIG. 10 is a front view illustrating a preferred position of a vibrator 200 in a mobile terminal according to Embodiment 3-2 of the present invention, and FIGS. 11A and 11B are sectional views taken along line III-III′ of FIG. 10.

As shown in FIGS. 10 and 11A, the vibrator 200 may be positioned at the edge of the lower surface of the first display part. Preferably, the vibrator 200 is constructed such that the vibration direction of the vibrator 200 is perpendicular to the lower surface of the first display part like the previously described Embodiment 3-2.

When the vibrator 200 is positioned at the edge of the lower surface of the first display part 100 as shown in FIG. 10, the vibration of the vibrator 200 vibrates a portion of the edge of the first display part, and the vibration is propagated along the lower surface of the first display part 100. Consequently, an advantage of this embodiment of the present invention is that the lower surface of the first display part can be vibrated even by vibration having a magnitude less than the case of FIG. 8.

In addition, referring to Embodiment 3-2, the vibrator 200 may be directly attached to the lower surface of the first display part 100 as shown in FIG. 11A. Alternatively, the vibrator 200 may be attached to the inside of the first housing as shown in FIG. 11B. The attachment of the vibrator 200 has been previously described in detail in connection with Embodiment 3-1, and therefore, a detailed description thereof will not be given below.

Voltage Square Wave Applied to Vibrator by Vibrator Driving Part

Hereinafter, the voltage square wave V, which is applied to the vibrator 200 by the vibrator driving part 300 such that a user of the terminal can feel instantaneous vibration sensation whenever the user of the terminal touches one of the key buttons on the touch screen. This will be described in more detail with reference to FIG. 7.

The inventor of the present application has performed experiments on several subjects. The objective of the experiments were to determine whether the subjects were able to experience and/or feel the same or similar vibration provided to the first display part 100 by the vibrator 200 to that of the conventional push-type buttons (e.g., tactile sensation corresponding to feel of the key buttons pressed downward/inward) while varying the frequency and the number of cycle repetitions of the voltage square wave V.

Before discussing the results of the experiment are, terms used to describe the results of the experiment are briefly defined as follows:

A term “voltage square wave V” refers to a voltage waveform generated by the vibrator driving part when a user of the terminal touches the touch screen once. Preferably, the voltage waveform is formed in the shape of a square wave. However, the voltage waveform is not limited to the shape of a square wave but may also be formed in other shapes, such as a sawtooth wave, a pulse wave, or a sine wave.

A term “number of cycle repetitions of voltage square wave” refers to a number of repetitions of one cycle T of the voltage square wave V. For example, the number of cycle repetitions of the voltage square wave V shown in FIG. 7B is 3.

A term “frequency f of voltage square wave” refers to a reciprocal of time corresponding to one cycle T of the voltage square wave V.

A term “magnitude M of voltage square wave” refers to a peak-to-peak amplitude of the voltage square wave V.

Referring to the experiment, the results of the experiment revealed that the magnitude of instantaneous vibration which a user of the terminal feels on the first display part is mainly influenced by the magnitude of the voltage square wave. Here, the magnitude of instantaneous vibration is partially influenced by the number of cycle repetitions of voltage square wave and the frequency of voltage square wave. This is because resonance may be generated between the voltage square wave and natural vibration frequency based on the material of the first display part and the material of the housing surrounding the first display part.

The experiment was carried out using a terminal having a vibrator provided to a touch screen, which is made of glass and surrounded by a housing made of polycarbonate, according to the present invention.

The experiments have revealed that it is preferable to have the following results. When the voltage square wave generated by the vibrator driving part has a number of cycle repetitions equaling 9 or less and a frequency of 300 Hz to 700 Hz, the subjects experienced instantaneous vibration sensation similar to tactile sensation obtained when the push type button(s) is actually pushed(e.g., conventional push-type buttons). Further, when the voltage square wave generated by the vibrator driving part preferably has a number of cycle repetitions equaling 5 or less and a frequency of 400 Hz to 600 Hz, the subjects experienced instantaneous vibration sensation further similar to tactile sensation obtained when one of the push type buttons is actually pushed. The results of the experiment are results obtained from actual experience of several subjects. Consequently, it should be noted that the results of the experiment are difficult to be calculated as accurate numerical data.

On the other hand, the vibrator 200 may be constructed to provide voltage square wave, associated with a first key button, having at least one of the number of cycle repetitions, the frequency, and the magnitude different from the number of cycle repetitions, frequency, and magnitude of the voltage square wave associated with a second key button. For example, if the user touches “5” key button which has a number of cycle repetitions equaling 3, and thereafter, the user touches “9” key button whose number of cycle repetitions equals 2, then the number of cycle repetitions associated with the selected key buttons are different. The same comparison can be made for the frequency and the magnitude. Furthermore, when the user of the terminal pushes the key buttons, the user of the terminal can perceive different instantaneous vibration sensations based on different voltage square waves without watching the second display part, whereby the user of the terminal can confirm which buttons have been pushed.

Such a construction may be easily used especially for visually impaired users. When the control part cannot determine which button the user of the terminal has intended to touch because the user of the terminal has simultaneously touched two or more buttons or touched the remaining area of the first display part excluding the key button display section, the vibrator may be constructed such that additional instantaneous vibration sensation indicating input error can be outputted from the vibrator. Alternatively, no response or no feedback can be provided to indicate error in pressing or touching the key buttons.

As apparent from the above description, the mobile terminal having the touch screen according to the present invention has the following effects.

According to the present invention, when a user of the terminal correctly touches the key buttons on the touch screen of the terminal, the user of the terminal can perceive, in the form of visual sensation, hearing sensation, and/or vibration sensation, that the key buttons have been correctly touched, and therefore, it is possible to more easily and conveniently manipulate the key buttons on the terminal having the touch screen. Especially, according to the present invention, when the user of the terminal touches the key buttons on the touch screen of the terminal, the user can perceive, in the form of vibration sensation, that the key buttons have been correctly touched, and therefore, it is possible for the user of the terminal to confirm whether the key buttons have been touched without watching an additional display part.

Furthermore, according to the present invention, when the user of the terminal pushes key buttons on the touch screen of the terminal, the user can feel or experience instantaneous vibration sensation similar to tactile sensation obtained when the conventional mechanical push buttons are actually pushed. Consequently, it is possible for any user experienced in using the conventional push-type mechanical buttons to easily manipulate the key buttons on the touch screen.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A terminal comprising:
a touch screen type display configured to display a key pad to input information; and
a controller configured to control the terminal,
wherein when a key button in the key pad is touched, the controller is configured to change an appearance of the touched key button.

2. The terminal of claim 1, wherein when the key button in the key pad is touched, the controller is configured to reverse a shape of the touched key button for a predetermined time.

3. The terminal of claim 1, wherein when the key button in the key pad is touched, the controller is configured to enlarge a shape of the touched key button for a predetermined time.

4. The terminal of claim 1, wherein when the key button in the key pad is touched, the controller is configured to change a color of the touched key button for a predetermined time.

5. The terminal of claim 1 further comprising:
a non touch screen type display.

6. The terminal of claim 1, wherein the terminal includes a mobile communication terminal.

7. A key input method on a terminal having a touch screen, comprising:
displaying an input unit on the touch screen;
sensing whether an input operation is performed through the input unit; and
instantaneously providing the touch screen with a vibration when the input operation is performed,
wherein the step of instantaneously providing comprises generating a vibration pulse using a vibrator which includes a coil, a linearly reciprocating mover constructed to be linearly reciprocated depending upon the change of a magnetic field generated from the coil, and a vibrator housing constructed to surround the coil and the linearly reciprocating mover, and
wherein the vibration pulse repeats 9 times or less.

8. The key input method according to claim 7, wherein the vibration pulse repeats 5 times or less.

9. A key input method on a terminal having a touch screen, comprising:
displaying an input unit on the touch screen;
sensing whether an input operation is performed through the input unit; and
instantaneously providing the touch screen with a vibration when the input operation is performed,
wherein the step of instantaneously providing comprises generating a vibration pulse using a vibrator which includes a coil, a linearly reciprocating mover constructed to be linearly reciprocated depending upon the change of a magnetic field generated from the coil, and a vibrator housing constructed to surround the coil and the linearly reciprocating mover, and
wherein the vibration pulse has a frequency of 300 Hz to 700 Hz.

10. The key input method according to claim 9, wherein the vibration pulse has a frequency of 400 Hz to 600 Hz.

11. A key input method on a terminal having a touch screen, comprising:
displaying an input unit on the touch screen;
sensing whether an input operation is performed through the input unit; and
instantaneously providing the touch screen with a vibration when the input operation is performed,
wherein the step of instantaneously providing comprises generating a vibration pulse using a vibrator which includes a coil, a linearly reciprocating mover constructed to be linearly reciprocated depending upon the change of a magnetic field generated from the coil, and a vibrator housing constructed to surround the coil and the linearly reciprocating mover, and
wherein the vibration pulse is controlled such that at least one of a number of vibration repetitions, a vibration frequency, and a magnitude of a corresponding voltage square wave differs based on a type of key button pushed by a user of the terminal.
